(19) United States
(12) Patent Application Publication
(10) Pub. No.: US 2016/0265671 A1
(43) Pub. Date: Sep. 15, 2016

(54) BALL VALVE

(71) Applicant: Azbil Corporation, Tokyo (JP)

(72) Inventors: Yoshio NOMAGUCHI, Tokyo (JP); Motohiro FURUYA, Tokyo (JP); Tomonori SHINTANI, Tokyo (JP)

(73) Assignee: Azbil Corporation, Tokyo (JP)

(21) Appl. No.: 15/065,294

(22) Filed: Mar. 9, 2016

(30) Foreign Application Priority Data
Mar. 9, 2015 (JP) 2015-045533

(51) Int. Cl. F16K 5/06; F16K 27/06

(52) U.S. Cl. CPC F16K 5/0605; F16K 27/067

(57) ABSTRACT

To obtain, even in a non-turbulent state, a capacity coefficient substantially the same as in a turbulent state, the downstream end of a wall surface of a flow rate characteristic window is the narrowest part in a flow channel of a valve main body and a through flow channel of a ball valve body and the wall surface of the flow channel between the narrowest part and the upstream end of the wall surface of the flow rate characteristic window is formed as a tapered surface tapered toward the smallest diameter part so that the flow channel is widened suddenly from the narrowest part of the flow rate characteristic window to the through flow channel.

### CROSS-REFERENCE TO RELATED APPLICATION

The present application claims the benefit of and priority to Japanese Patent Application No. 2015-045533, filed on Mar. 9, 2015, the entire contents of which are incorporated by reference herein.

### TECHNICAL FIELD

The present invention relates to a ball valve provided with a ball valve body having a through flow channel.

### BACKGROUND ART

Conventionally, a ball valve having, as a plug, a ball valve body with a through flow channel is known as a flow control valve used to control the flow rate of various types of fluid such as, for example, cold/warm water for air conditioning.

FIG. 13 illustrates the main part of the ball valve disclosed in PTL 1. This ball valve 1 (1E) includes a valve main body 4 that forms a flow channel 3 of fluid 2, a ball valve body 5 provided inside the valve body 4, a valve shaft 6 rotating the ball valve body 5 from the outside of the valve body 4.

The ball valve body 5 has a through flow channel 7 extending orthogonally to the axial line of the valve shaft 6, is disposed in the middle in the valve main body 4 so as to be rotatable about the valve shaft 6 via two seat rings 8 positioned in front and rear respectively, and the outer peripheral surface forms a spherical seat in contact with the seat rings 8. The fluid 2 flows from the left (upstream side) to the right (downstream side) in the drawing.

The through flow channel 7 of the ball valve body 5 has a through hole extending orthogonally to the axial line of the valve shaft 6 and an opening 71 of the through hole (through flow channel) 7 on the upstream side is a flow rate characteristic window and an opening 72 on the downstream side is formed in a circle having a diameter of D.

FIG. 14(a) is a diagram illustrating the ball valve body 5 seen from the upstream side of the through flow channel 7 and FIG. 14(b) is a diagram illustrating the ball valve body 5 seen from the downstream side of the through flow channel 7.

The opening (flow rate characteristic window) 71 on the upstream side has a shape (substantially a sector seen in the rotational direction (direction of arrow R) of the ball valve body 5 in this example) indicating a predetermined flow rate characteristic. In addition, there is a cavity (cylindrical cavity) on the downstream side of the flow rate characteristic window 71, the cavity having the same diameter as the circular opening 72 and communicating with the opening 72.

The ball valve body 5 has a concavity 9 at the center of its upper surface and a lower end 6a of the valve shaft 6 fits into the concavity 9. The valve shaft 6 is rotatably inserted into a cylindrical part 10 at the center of the valve main body 4 via an O-ring 11 and its upper end 6b projects above the cylindrical part 10. By driving the valve shaft 6 manually or using a driving device such as a driving motor, the ball valve body 5 rotates about the valve shaft 6 in an angle range of substantially 90 degrees in the direction of arrow R or in the opposite direction.

FIG. 13 illustrates the state in which the ball valve 1E is fully opened. When the ball valve body 5 is rotated 90 degrees in this state, the opening 71 on the upstream side and the opening 72 on the downstream side are fully closed. In an intermediate opening degree between full opening and full closing, the amount of fluid flowing through the valve main body 4 depends on the opening amount of the opening (flow rate characteristic window) 71 on the upstream side.

The ball valve 1E is installed, for example, in the middle of a pipe through which cold/warm water for air conditioning flows and the valve size (capacity coefficient) corresponding to the flow rate required for the installation in the pipe is selected. Selection of the valve capacity coefficient corresponding to the required flow rate is referred to as sizing (see, for example, NPL 1).

### PRIOR ART DOCUMENTS

### Patent Documents

[PTL 1] JP-A-2003-113948
[PTL 2] Japanese Patent No. 5113722

### Non-Patent Documents

[NPL 1] JIS B 2005-2-1 (Part II: Flow capacity—Section 1: Sizing equations for fluid flow under installed conditions)

### SUMMARY OF THE INVENTION

### Problems to be Solved by the Invention

In this ball valve 1E, when the fluid flows through the flow rate characteristic window 71, a flow along the wall surface 71a of the flow rate characteristic window 71 is separated from the downstream end of the wall surface 71a and a most contracted flow part (section A in FIG. 15) is generated immediately downstream of the flow rate characteristic window 71. The state of the flow in the most contracted flow part determines the capacity coefficient of the valve.

In the conventional ball valve 1E, the wall surface (the wall surface of the flow channel) 71a of the flow rate characteristic window 71 is a plane parallel with the flow direction of the fluid and the flow in the most contracted flow part is significantly affected by friction on the wall surface 71a of the flow rate characteristic window 71. In this case, friction (friction in section B in FIG. 15) on the wall surface 71a of the flow rate characteristic window 71 depends on whether the flow is in the non-turbulent state (low-Reynolds number flow at a low differential pressure, a low temperature, or the like) or in the turbulent state.

Accordingly, the valve capacity coefficient in the non-turbulent state greatly differs from the valve capacity coefficient in the turbulent state, so correction using a specific coefficient (F_{R} value) called a Reynolds number coefficient needs to be performed. Generally, as the non-turbulent state progresses, the F_{R} value is smaller. That is, the capacity coefficient of the valve is reduced by the amount obtained by multiplication by the F_{R} value in the non-turbulent state.

The technique in PTL 2 calculates the flow rate of the fluid flowing through the conduit of a flow control valve using a reference table indicating the relationship between the valve opening degree and the flow rate coefficient (capacity coefficient) at a predetermined reference differential pressure and a characteristic table indicating the relationship between the valve opening degree and the flow rate coefficient (capacity coefficient) at a differential pressure lower than or higher than the reference differential pressure.

The method disclosed in PTL 2 can calculate the flow rate by obtaining the flow rate coefficient (capacity coefficient) assumed when the valve opening degree and the differential pressure change using the characteristic table. However, when this method is applied to the conventional ball valve 1E, since the kinetic viscosity of fluid changes when the fluid temperature greatly changes and the state of a flow in the most contracted flow part generated immediately downstream of the flow rate characteristic window 71 changes, the difference between the calculated flow rate and the actual flow rate increases, thereby making it difficult to calculate the flow rate accurately.

The invention addresses the above problems with an object of providing a ball valve that can obtain, even in the non-turbulent state, a capacity coefficient substantially the same as in the turbulent state.

### Means for Solving the Problems

To achieve such an object, according to the invention, there is provided a ball valve including a ball valve body having a through flow channel and adjusting an opening amount of a flow rate characteristic window for fluid flowing through a flow channel in a valve main body by rotating the ball valve body about a valve shaft, in which a wall surface of the flow channel between a narrowest part in the flow channel of the valve main body and the through flow channel of the ball valve body and a part upstream of the narrowest part by a predetermined distance is formed as a tapered surface tapered toward the narrowest part.

In the invention, the wall surface of the flow channel between the narrowest part in the flow channel of the valve main body and the through flow channel of the ball valve body and the part upstream of the narrowest part by a predetermined distance is formed as a tapered surface tapered toward the narrowest part. Accordingly, the wall surface of the flow channel is gradually tapered from the part upstream of the narrowest part by the predetermined distance toward the narrowest part and a flow in the most contracted flow part generated immediately downstream of the narrowest part is not easily affected by friction on the wall surface of the flow channel. In this case, the flow in the most contracted flow part is determined by how the fluid is separated from the narrowest part. Accordingly, the flow state of the most contracted flow part does not change between the non-turbulent state and the turbulent state and the capacity coefficient of the valve in the non-turbulent state is substantially the same as in the turbulent state.

Although the wall surface of the flow channel between the narrowest part in the flow channel of the valve main body and the through flow channel of the ball valve body and the part upstream of narrowest part by a predetermined distance is formed as a tapered surface tapered toward the narrowest part in the invention, the tapered surface may be formed on the wall surface of the through flow channel of the ball valve body or on the wall surface of the flow channel of the valve main body. For example, the wall surface of the flow rate characteristic window of the ball valve body may be formed as a tapered surface or the inner wall surface of the retainer provided in the valve main body may be formed as a tapered surface.

### Advantage of the Invention

The wall surface of the flow channel between the narrowest part in the flow channel of the valve main body and the through flow channel of the ball valve body and the part upstream of the narrowest part by a predetermined distance is formed as a tapered surface tapered toward the narrowest part in the invention, so a flow in the most contracted part generated immediately downstream of the narrowest part is not easily affected by friction on the wall surface of the flow channel and it is possible to obtain, even in non-turbulent state, a capacity coefficient substantially the same as in the turbulent state by eliminating differences in the flow state of the most contracted flow part between the non-turbulent state and the turbulent state.

### BRIEF DESCRIPTION OF THE DRAWINGS

FIG. 1 illustrates the main part of a ball valve according to an embodiment (embodiment 1) of the invention.

FIG. 2 is a diagram illustrating the valve main body of the ball valve seen from the upstream side and the downstream side.

FIG. 3 illustrates a most contracted part generated downstream of the flow rate characteristic window of the ball valve.

FIG. 4 illustrates the relationship between the taper angle of the wall surface of the flow rate characteristic window of the ball valve and the F_{R} value.

FIG. 5 illustrates the main part of a ball valve according to embodiment 2.

FIG. 6 is an enlarged view of the main part of the ball valve according to embodiment 2.

FIG. 7 illustrates the main part of a ball valve according to embodiment 3.

FIG. 8 is an enlarged view of the main part of the ball valve according to embodiment 3.

FIG. 9 illustrates the main part of a ball valve according to embodiment 4.

FIG. 10 is a diagram illustrating the valve main body of the ball valve according to embodiment 4 seen from the upstream side and the downstream side.

FIG. 11 illustrates the test results of the ball valve according to embodiment 2.

FIG. 12 illustrates the test results of a conventional ball valve corresponding to the ball valve according to embodiment 2.

FIG. 13 illustrates the main part of the ball valve disclosed in PTL 1.

FIG. 14 is a diagram illustrating the ball valve body of the ball valve disclosed in PTL 1 seen from the upstream side and the downstream side.

FIG. 15 illustrates a most contracted flow part generated downstream of a flow rate characteristic window of the ball valve disclosed in PTL 1.

FIG. 16 illustrates the main part of the conventional ball valve corresponding to the ball valve according to embodiment 2.

### MODE FOR CARRYING OUT THE INVENTION

Embodiments of the invention will be described in detail below with reference to the drawings.

### Embodiment 1

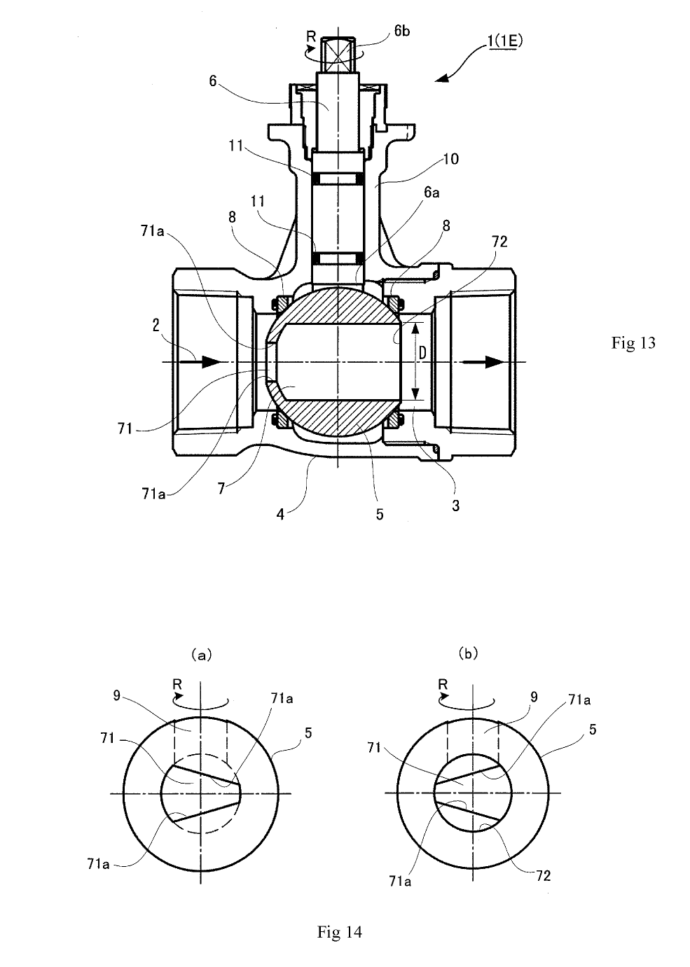

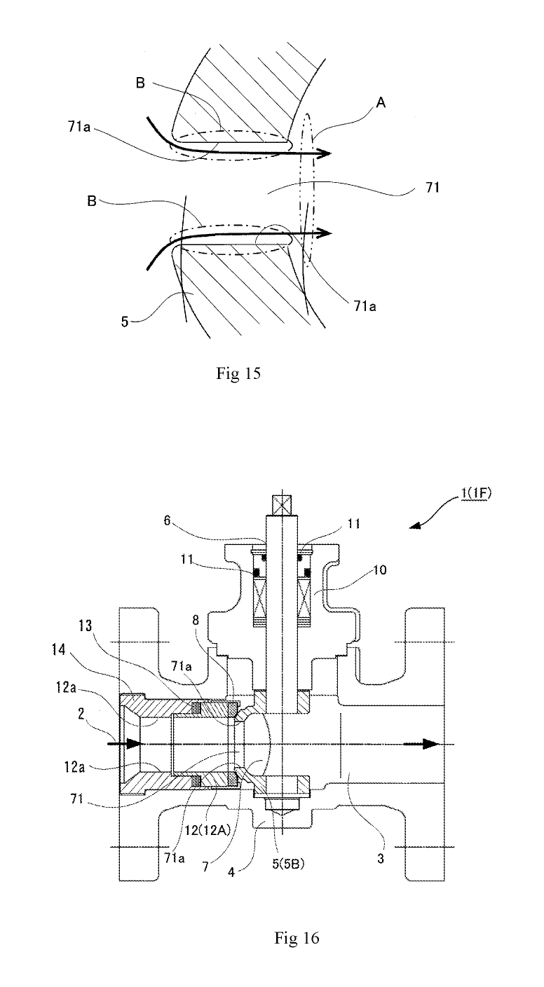

FIG. 1 illustrates the main part of a ball valve according to an embodiment (embodiment 1) of the invention. In this drawing, components having the same reference numerals as in FIG. 13 are the same as or similar to components in FIG. 13 and descriptions are omitted.

In a ball valve 1 (1A) according to embodiment 1, the wall surface (the wall surface of the flow channel) 71a′ of the flow rate characteristic window 71 is formed as a tapered surface tapered from upstream to downstream. That is, the downstream end of the wall surface 71a′ of the flow rate characteristic window 71 is the narrowest part of the flow channel 3 of the valve main body 4 and the through flow channel 7 of the ball valve body 5 and the wall surface 71a′ of the flow channel between the narrowest part and the upstream end of the wall surface 71a′ of the flow rate characteristic window 71 is formed as a tapered surface tapered toward the narrowest part so that the flow channel is widened suddenly from the narrowest part of the flow rate characteristic window 71 to the through flow channel 7.

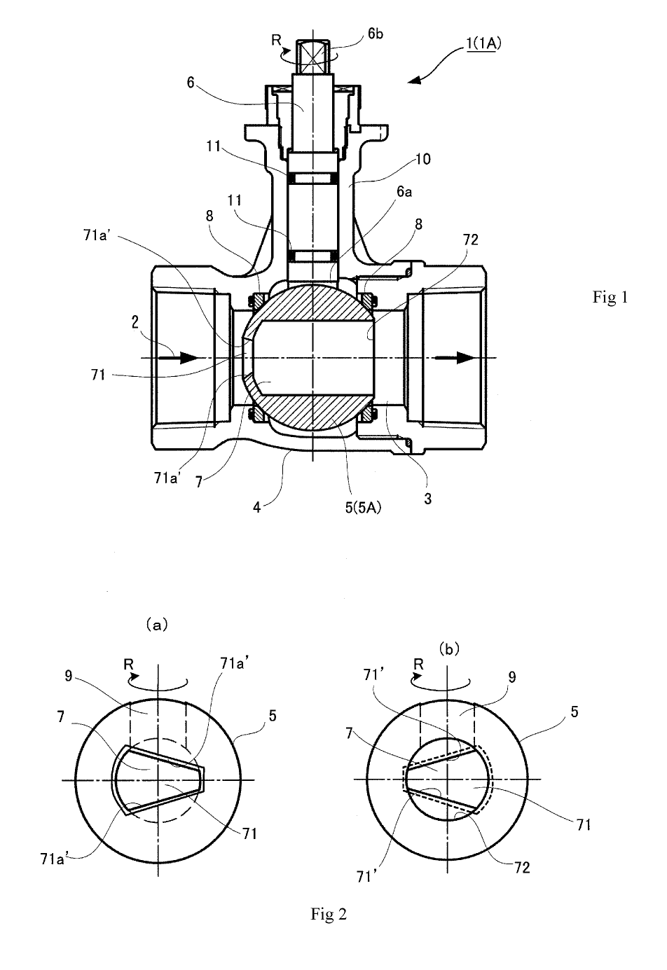

FIG. 2(a) is a diagram illustrating the ball valve body 5 seen from the upstream side of the through flow channel 7 and FIG. 2(b) is a diagram illustrating the ball valve body 5 seen from the downstream side of the through flow channel 7.

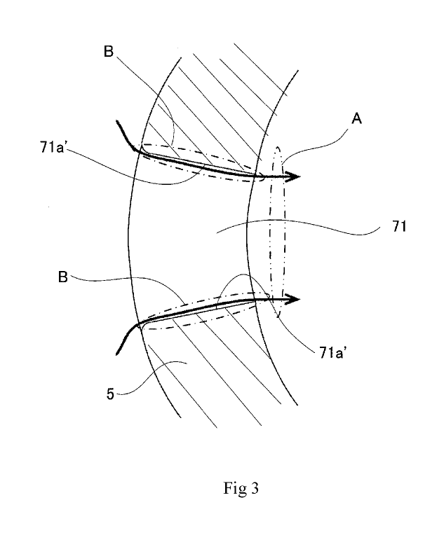

The wall surface 71a′ of the flow rate characteristic window 71 is formed as a tapered surface tapered toward the narrowest part in the ball valve 1A according to embodiment 1, so the wall surface 71a′ is gradually tapered toward the narrowest part and a flow in the most contracted flow part (section A in FIG. 3) generated immediately downstream of the narrowest part is not easily affected by friction (friction in section B illustrated in FIG. 3) on the wall surface 71a′. In this case, the flow in the most contracted flow part is determined by how the fluid is separated from the narrowest part. Accordingly, the flow state of the most contracted flow part does not change between the non-turbulent state and the turbulent state and the capacity coefficient of the valve in the non-turbulent state is substantially the same as in the turbulent state.

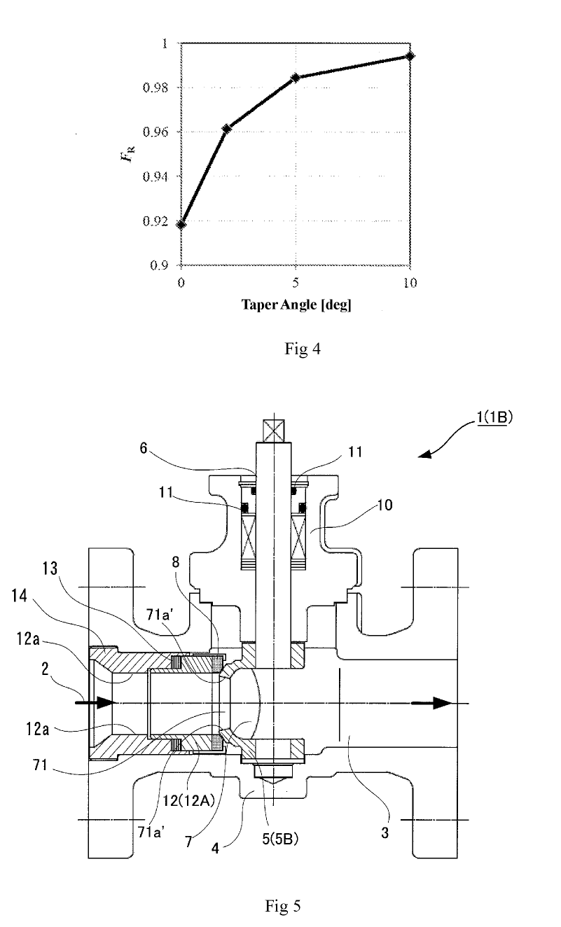

This makes the F_{R} value in the non-turbulent state substantially the same as the F_{R} value in the turbulent state in the embodiment, thereby eliminating the need to correct the capacity coefficient of the valve in the non-turbulent state. FIG. 4 illustrates the relationship between the taper angle of the wall surface 71a′ of the flow rate characteristic window 71 and the F_{R} value. As this relationship shows, a taper angle from approximately 5 to 10 degrees provides an F_{R} value close to 1.

When the flow rate is measured using the method disclosed in PTL 2 in the embodiment (that is, when the valve opening degree and valve front-rear differential pressure are measured and the flow rate is calculated using the flow rate coefficient (capacity coefficient) table stored in the valve), even if the kinetic viscosity changes due to a change in the fluid temperature, the flow rate can be measured accurately because the flow state of the most contracted flow part does not change.

### Embodiment 2

FIG. 5 illustrates a ball valve according to embodiment 2. Although the ball valve body 5 is spherical in the ball valve 1A (FIG. 1) according to embodiment 1, the ball valve body 5 is semi-spherical in the ball valve 1 (1B) according to embodiment 2. For distinction from the ball valve body according to embodiment 1, the ball valve body according to embodiment 1 is referred to as a ball valve body 5A and the ball valve body according to embodiment 2 is referred to as a ball valve body 5B.

The ball valve body 5B is egg-shaped and has the through flow channel 7 extending orthogonally to the axial line of the valve shaft 6. The opening 71 upstream of the through flow channel 7 is the flow rate characteristic window as in the ball valve body 5A. In addition, the outer peripheral surface of the ball valve body 5B forms a spherical seat in contact with a seat ring 8. The fluid 2 flows from the left (upstream side) to the right (downstream side) in the drawing.

In the valve main body 4, a retainer 12, a spring 13, and a conduit member 14 fit into the conduit disposed upstream of the ball valve body 5B. When the conduit member 14 is screwed into the conduit of the valve main body 4, the retainer 12 pushes the seat ring 8 against the outer peripheral surface of the ball valve body 5B via the spring 13.

As in the ball valve 1A according to embodiment 1, the wall surface (the wall surface of the flow channel) 71a′ of the flow rate characteristic window 71 is formed as a tapered surface tapered from upstream to downstream in the ball valve 1B according to embodiment 2.

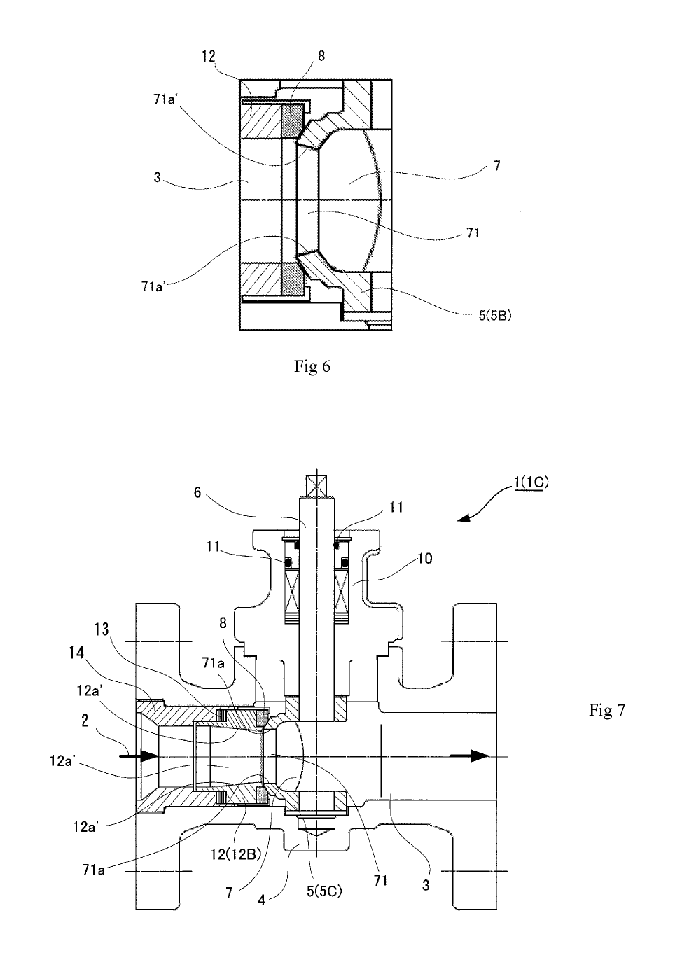

That is, as illustrated in the enlarged view of the main part in FIG. 6, the downstream end of the wall surface 71a′ of the flow rate characteristic window 71 is the narrowest part in the flow channel 3 of the valve main body 4 and the through flow channel 7 of the ball valve body 5B and the wall surface 71a′ of the flow channel between the narrowest part and the upstream end of the wall surface 71a′ of the flow rate characteristic window 71 is formed as a tapered surface tapered toward the narrowest part so that the flow channel is widened suddenly from the narrowest part of the flow rate characteristic window 71 to the through flow channel 7.

### Embodiment 3

FIG. 7 illustrates a ball valve according to embodiment 3. The wall surface (the wall surface of the flow channel) 71a′ of the flow rate characteristic window 71 is formed as a tapered surface tapered from upstream to downstream in a ball valve 1C (FIG. 5) according to embodiment 2. However, in the ball valve 1 (1C) according to embodiment 3, the wall surface (71a) of the flow rate characteristic window 71 is not a tapered surface and the inner wall surface (the wall surface of the flow channel) 12a′ of the retainer 12 is a tapered surface.

For distinction from the retainer 12 according to embodiment 2, the retainer according to embodiment 2 is referred to as a retainer 12A and the retainer according to embodiment 3 is referred to as a retainer 12B. In addition, the ball valve body according to embodiment 3 is referred to as a ball valve body 5C.

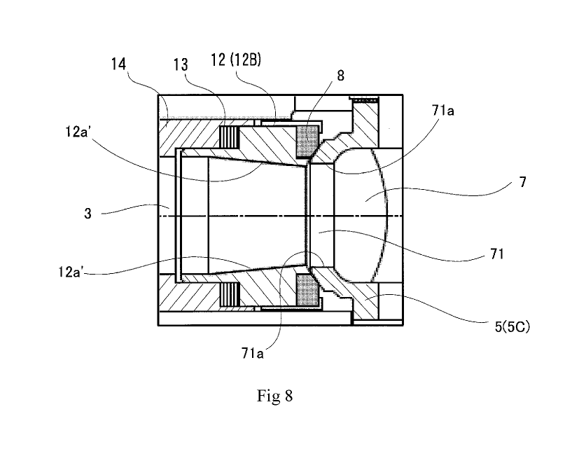

That is, in the ball valve 1C according to embodiment 3, as illustrated in the enlarged view of the main part in FIG. 8, the downstream end of an inner wall surface 12a′ of a retainer 12B is the narrowest part of the flow channel 3 of a valve main body 4 and the through flow channel 7 of the ball valve body 5C and the inner wall surface 12a′ between the narrowest part and a predetermined position upstream of the inner wall surface 12a′ of the retainer 12B is formed as a tapered surface tapered toward the smallest diameter part.

In the ball valve 1C, the flow channel is widened suddenly from the narrowest part of the retainer 12B to the through flow channel 7 via the flow rate characteristic window 71 of the ball valve body 5C. The flow rate characteristic window 71 of the ball valve body 5C is wider than the narrowest part of the retainer 12B.

### Embodiment 4

FIG. 9 illustrates a ball valve according to embodiment 4. The flow rate characteristic window 71 of the ball valve body 5A is provided on the upstream side in the ball valve 1A (FIG. 1) according to embodiment 1. However, in the ball valve 1 (1D) according to embodiment 4, the flow rate characteristic window 71 of the ball valve body 5B is provided on the downstream side. Also in the ball valve 1D, the wall surface (the wall surface of the flow channel) 71a′ of the flow rate characteristic window 71 is formed as a taper surface tapered from upstream to downstream.

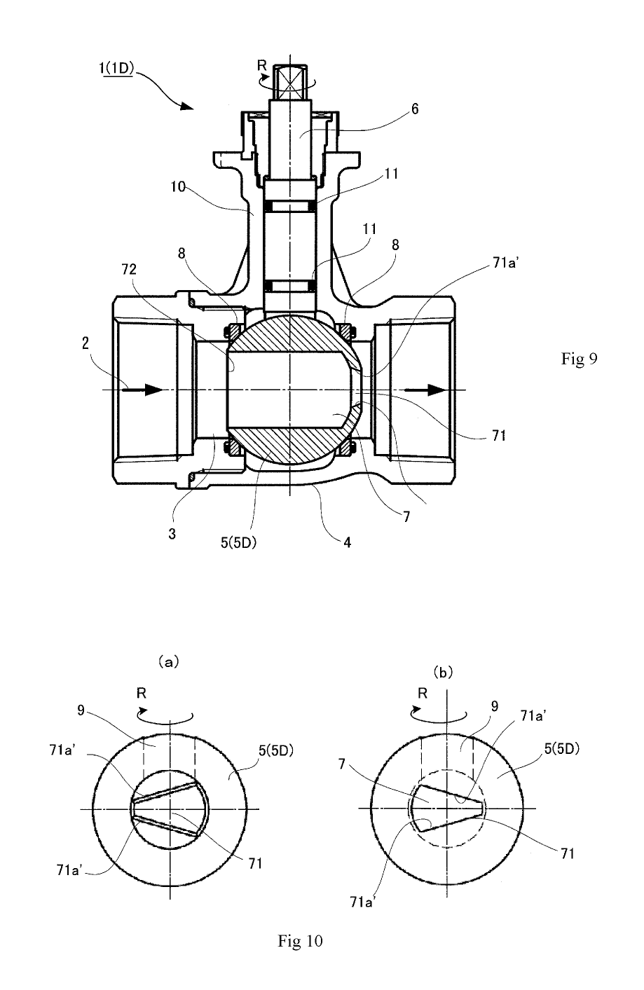

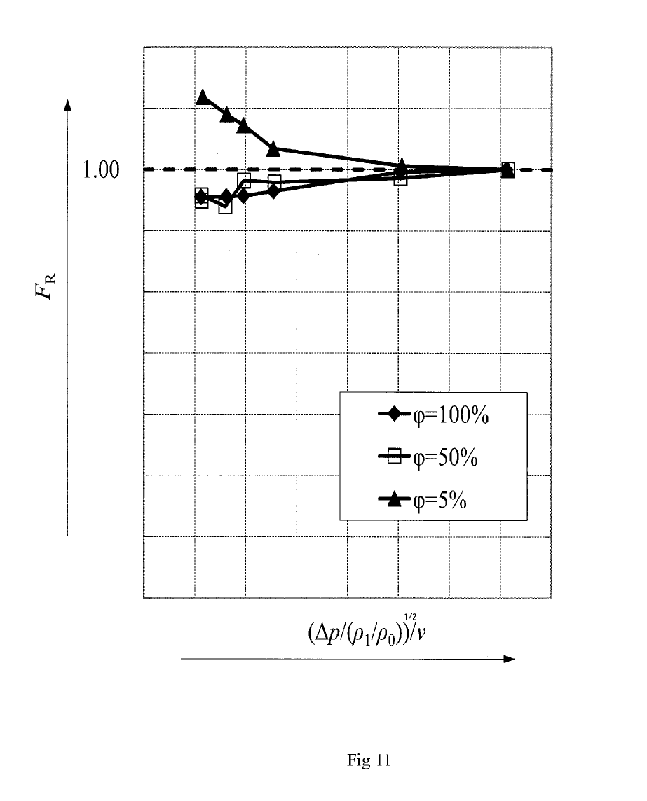

Since the flow rate characteristic window 71 is positioned on the downstream side in the ball valve 1D, the wall surface 71a′ of the flow rate characteristic window 71 is formed as a taper surface thickened from the outer peripheral surface of the ball valve body 5 toward the through flow channel 7. FIG. 10(a) is a diagram illustrating the ball valve body 5 (5D) seen from the upstream side of the through flow channel 7 and FIG. 10(b) is a diagram illustrating the ball valve body 5 (5D) seen from the downstream side of the through flow channel 7.

### [Test Results]

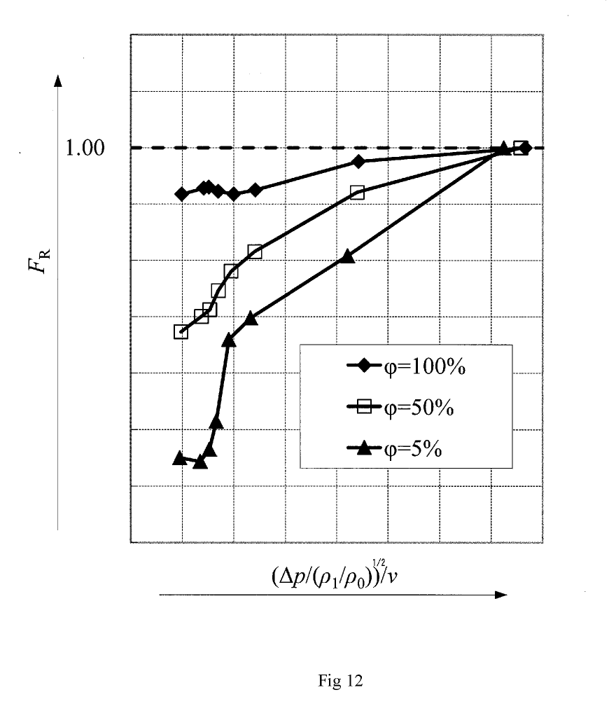

FIGS. 11 and 12 illustrate the test results in which the coefficient equivalent to the Reynolds number was assumed to be (Δρ/(ρ₁/ρ₀))^{1/2}/υ and the relationship between (Δρ/(ρ₁/ρ₀))^{1/2}/υ and the F_{R} value (Reynolds number coefficient) was obtained.

FIG. 11 illustrates the test results of the ball valve 1B (in which the wall surface of the flow rate characteristic window is formed as a tapered surface) according to embodiment 2 in FIG. 5 and FIG. 12 illustrates the test results of a conventional ball valve 1F (in which the wall surface of the flow rate characteristic window is not formed as a tapered surface) corresponding to the ball valve 1B according to embodiment 2 as illustrated in FIG. 16.

In the test results illustrated in FIGS. 11 and 12, φ represents the relative capacity coefficient (the ratio of the flow rate at any valve opening degree to the flow rate at the full open state), Δp represents the differential pressure between upstream and downstream, ρ₁ represents the fluid density at the fluid temperature, ρ₀ represents the fluid density at the reference temperature, and u represents the kinetic viscosity. When the value of (Δρ/(ρ₁/ρ₀))^{1/2}/υ is small, the flow is put in the non-turbulent state (low speed and high kinetic viscosity (that is, low temperature)). In comparison between FIG. 11 and FIG. 12, the F_{R} value in the non-turbulent state has been significantly improved in the prototype model as compared with the conventional mode.

In the ball valve 1D illustrated in FIG. 9, the wall surface 71a′ of the flow rate characteristic window 71a of a ball valve body 5D does not need to be formed as a tapered surface. Instead, a retainer may be provided downstream of the ball valve body 5D and the inner wall surface of the retainer provided downstream of this ball valve body may be formed as a tapered surface. In this case, a narrowest part is provided in the retainer and the inner wall surface between the narrowest part and a predetermined position upstream of the inner wall surface of the retainer is formed as a tapered surface tapered toward the narrowest part.

### Expansion of Embodiments

Although the invention has been described above with reference to embodiments, the invention is not limited to the above embodiments. Various changes understandable to those skilled in the art can be made to the structure and details of the invention within the scope of the invention.

### DESCRIPTION OF REFERENCE NUMERALS AND SIGNS

1 (1A to 1D): ball valve, 2: fluid, 3: flow channel, 4: valve main body, 5 (5A to 5D): ball valve body, 6: valve shaft, 7: through flow channel, 12 (12A, 12B): retainer, 12a, 12a′: inner wall surface (wall surface of flow channel), 71: opening (flow rate characteristic window), 71a, 71a′: wall surface (wall surface of flow channel).

1. A ball valve comprising:
a ball valve body having a through flow channel;
a valve shaft configured to rotate the ball valve body such that an opening amount of a flow rate characteristic window for fluid flowing through a flow channel in a valve main body is adjusted,
wherein a wall surface of the flow channel between a smallest diameter part in the flow channel of the valve main body and the through flow channel of the ball valve body and a part upstream of the smallest diameter part by a predetermined distance is formed as a tapered surface tapered toward the smallest diameter part.

2. The ball valve according to claim 1,
wherein the tapered surface is formed on the wall surface of the through flow channel of the ball valve body.

3. The ball valve according to claim 1,
wherein the tapered surface is formed on the wall surface of the flow channel of the valve main body.
